(19) United States
(12) Patent Application Publication
(10) Pub. No.: US 2008/0305863 A1
(43) Pub. Date: Dec. 11, 2008

(54) GAMING MACHINE, CONTROL METHOD THEREOF AND PLAYING METHOD OF CARD GAME

(75) Inventor: Hirobumi TOYODA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp, Tokyo (JP)

(21) Appl. No.: 11/936,337

(22) Filed: Nov. 7, 2007

(30) Foreign Application Priority Data
Nov. 20, 2006 (JP) 2006-313472

(51) Int. Cl. A63F 9/24; A63F 13/00

(52) U.S. Cl. 463/27

(57) ABSTRACT

A gaming machine comprises a controller, a first display and a second display. The controller is operable to (a) execute a poker game as a base game, (b) execute the base game to be played subsequently as a high-probability game with a raised winning probability for some game plays if the predetermined combination is a specific combination, (c) accumulate some of a payout amount for a jackpot, and (d) execute a chance game for determining whether or not to award the jackpot based on the player's operation if the high-probability game has brought a predetermined outcome. The first display displays images related to the base game. The second display is provided independently from the first display and displays images related to the chance game.

### CROSS-REFERENCE TO RELATED APPLICATION

This application is based upon and claims priority of Japanese Patent Application No. 2006-313472, filed on Nov. 20, 2006, the entire contents of which are incorporated herein by reference.

This application is related to co-pending U.S. patent application entitled “GAMING MACHINE AND CONTROL METHOD THEREOF” referred to as the prior Japanese Patent Application No. 2006-309025, filed in Japan on Nov. 15, 2006, co-pending U.S. patent application entitled “GAMING MACHINE, CONTROL METHOD THEREOF AND PLAYING METHOD OF CARD GAME” referred to as the prior Japanese Patent Application No. 2006-313469, filed in Japan on Nov. 20, 2006, and co-pending U.S. patent application entitled “GAMING MACHINE AND CONTROL METHOD THEREOF” referred to as the prior Japanese Patent Application No. 2006-313470, filed in Japan on Nov. 20, 2006. The teachings of the co-pending applications are incorporated herein by reference to the extent they not do conflict with the teachings herein.

### BACKGROUND OF THE INVENTION

1. Field of the Invention

The present invention relates to a gaming machine, a control method thereof and a playing method of a card game.

2. Description of Related Art

With a conventional gaming machine such as a poker machine installed in a casino, a base game is executed in which a winning is awarded when dealt cards constitute a predetermined card combination. With such a gaming machine, one or more medals are provided to a player for each poker game according to the number of inserted medals and odds of a winning poker hand.

In addition, a gaming machine is provided, which executes high-probability games with raised winning probability, recently. For example, a gaming machine is provided, which deals two sets of cards to each player, that is, ten cards in all (which is more than traditional one set of five cards). Each of the players tries to create one poker hand by combining the cards in two sets (see U.S. Pat. No. 5,882,260).

Furthermore, there is a new gaming style called double down game, recently. In the double down game, a player can try to double a payout amount, which has been awarded according to a poker hand in a general poker game, in order to increase the payout amount.

### SUMMARY OF THE INVENTION

It is an object of the present invention to provide a gaming machine having a new gaming style which enhances expectation for more payout amounts, a control method thereof and a playing method of a card game.

A first aspect of the present invention provides a gaming machine for playing with plural kinds of cards, which comprises a controller, a first display and a second display. The controller operable to (a) execute a base game, in which some cards selected by a player among initially dealt cards can be replaced with other cards and a payout is awarded if a predetermined combination is created by the finally dealt cards, (b) execute the base game to be played subsequently as a high-probability game with a raised winning probability for some game plays if the predetermined combination is a specific combination, (c) accumulate some of a payout amount for a jackpot, and (d) execute a chance game for determining whether or not to award the jackpot based on the players operation if the high-probability game has brought a predetermined outcome. The first display is controlled by the controller for displaying images related to the base game. The second display is controlled by the controller and provided independently from the first display for displaying images related to the chance game.

It is preferable that the controller is operable to (i) execute a second game for determining whether or not to execute the chance game if the high-probability game has brought the predetermined outcome in (d), (ii) display images related to the chance game on both the first display and the second display, and (iii) display images related to the second game on the second display.

It is further preferable that the controller is operable to (iv) execute an extra game for determining whether or not to execute the second game if the high-probability game has brought the predetermined outcome in (d), and (v) display images related to the base game and the extra game on the first display.

A second aspect of the present invention provides a gaming machine for playing with plural kinds of cards, which comprises a controller, a first display and a second display. The controller operable to (a) execute a base game, in which some cards selected by a player among initially dealt cards can be replaced with other cards and a payout is awarded if a predetermined combination is created by the finally dealt cards, (b) execute the base game to be played subsequently as a high-probability game with a raised winning probability for some game plays if the predetermined combination is a specific combination, (c) accumulate some of a payout amount for a jackpot, and (d) execute a second game if the high-probability game has brought a predetermined outcome, and (e) execute a chance game for determining whether or not to award the jackpot based on the player's operation if the second game has brought a predetermined outcome. The first display is controlled by the controller for displaying images related to the base game and the chance game. The second display is controlled by the controller and provided independently from the first display for displaying images related to the second game and the chance game.

It is preferable that the controller is operable to (i) execute an extra game for determining whether or not to execute the second game if the high-probability game has brought the predetermined outcome in (d), and (ii) display images related to the base game and the extra game on the first display.

A third aspect of the present invention provides a gaming machine for playing with plural kinds of cards, which comprises a controller, a first display and a second display. The controller operable to (a) execute a base game, in which some cards selected by a player among initially dealt cards can be replaced with other cards and a payout is awarded if a predetermined combination is created by the finally dealt cards, (b) execute the base game to be played subsequently as a high-probability game with a raised winning probability for some game plays if the predetermined combination is a specific combination, (c) accumulate some of a payout amount for a jackpot, (d) execute an extra game if the high-probability game has brought a predetermined outcome, (e) execute a second game if the extra game has brought a predetermined outcome, and (f) execute a chance game for determining whether or not to award the jackpot based on the player's operation if the second game has brought a predetermined outcome. The first display is controlled by the controller for displaying images related to the base game, the extra game, and the chance game. The second display is controlled by the controller and provided independently from the first display for displaying images related to the second game and the chance game.

A fourth aspect of the present invention provides a control method of a gaming machine, which executes a game with plural kinds of cards and comprises a controller, a first display and a second display provided independently from the first display. The controller is operable to (a) execute a base game, in which some cards selected by a player among initially dealt cards can be replaced with other cards and a payout is awarded if a predetermined combination is created by the finally dealt cards, (b) execute the base game to be played subsequently as a high-probability game with a raised winning probability for some game plays if the predetermined combination is a specific combination, (c) accumulate some of a payout amount for a jackpot, (d) execute a chance game for determining whether or not to award the jackpot based on the player's operation if the high-probability game has brought a predetermined outcome, (e) display images related to the base game on the first display, and (f) display images related to the chance game on the second display.

It is preferable that the controller is operable to (i) execute a second game for determining whether or not to execute the chance game if the high-probability game has brought the predetermined outcome in (d), (ii) display images related to the chance game on both the first display and the second display, and (iii) display images related to the second game on the second display.

It is further preferable that the controller is operable to (iv) execute an extra game for determining whether or not to execute the second game if the high-probability game has brought the predetermined outcome in (d), and (v) display images related to the base game and the extra game on the first display.

A fifth aspect of the present invention provides a playing method of a card game, comprising (a) executing a base game at first gaming field, in which some cards selected by a player among initially dealt cards can be replaced with other cards and a payout is awarded if a predetermined combination is created by the finally dealt cards; (b) executing the base game to be played subsequently as a high-probability game with a raised winning probability for some game plays if the predetermined combination is a specific combination; (c) accumulating some of a payout amount for a jackpot; and (d) executing a chance game at a second gaming field for determining whether or not to award the jackpot based on the player's operation if the high-probability game has brought a predetermined outcome, the second gaming field being provided independently from the first gaming field.

### BRIEF DESCRIPTION OF THE DRAWINGS

FIG. 1 is a flow chart of a game according to an embodiment of the present invention;

FIG. 2 is a perspective view illustrating an appearance of a poker machine according to the present embodiment;

FIG. 3 is a block diagram of the poker machine according to the present embodiment;

FIG. 4 is a flow chart of a main processing in the poker machine according to the present embodiment;

FIG. 5 is a flow chart of a bet processing in the poker machine according to the present embodiment;

FIG. 6 is a flow chart of an internal sortition processing in the poker machine according to the present embodiment;

FIG. 7 is a flow chart of a card replace processing in the poker machine according to the present embodiment;

FIG. 8 is a flow chart of a card redisplay processing in the poker machine according to the present embodiment;

FIG. 9 is a flow chart of an outcome determination processing in the poker machine according to the present embodiment;

FIG. 10 is a flow chart of a chance game processing in the poker machine according to the present embodiment;

FIGS. 11A and 11B illustrate display screens of a first and second displays in the poker machine according to the present embodiment;

FIGS. 12A and 12B illustrate display screens of the first and second displays in the poker machine according to the present embodiment;

FIGS. 13A and 13B illustrate display screens of the first and second displays in the poker machine according to the present embodiment;

FIGS. 14A and 14B illustrate display screens of the first and second displays in the poker machine according to the present embodiment;

FIGS. 15A and 15B illustrate display screens of the first and second displays in the poker machine according to the present embodiment;

FIGS. 16A and 16B illustrate display screens of the first and second displays in the poker machine according to the present embodiment;

FIGS. 17A and 17B illustrate display screens of the first and second displays in the poker machine according to the present embodiment; and

FIGS. 18A and 18B illustrate display screens of the first and second displays in the poker machine according to the present embodiment.

### DETAILED DESCRIPTION OF THE EMBODIMENT

### [Outline of Playing Method]

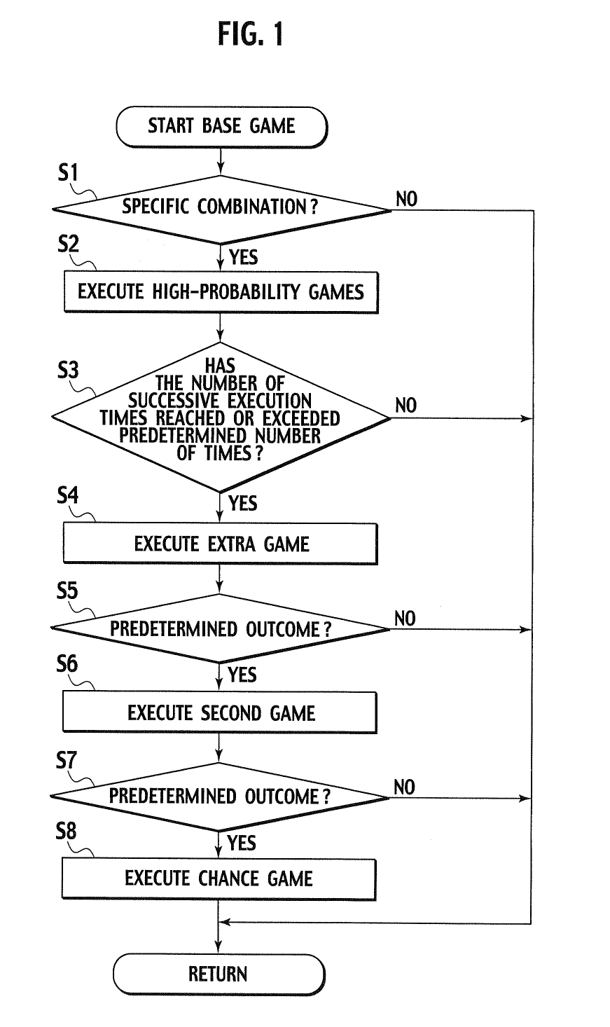

FIG. 1 is a flow chart describing a playing method according to an embodiment of the present invention. A game played by the playing method is a kind of poker game. Base games are executed in this poker game. In each of the base games, some cards selected by a player among initially dealt cards are replaced with other cards, and then a payout is awarded when a winning card combination (winning hand) is created with cards of the player. In each of the base game, some of a payout amount is accumulated for a jackpot (extra bonus). In a base game, it is determined whether or not the winning card combination is a specific combination (e.g., “flush” of hearts or diamonds) at first (step S1). Subsequently, if it is determined in step S1 that the winning card combination is the specific combination, high-probability games with raised winning probability are executed (step S2). The several high-probability games are executed successively and it is determined whether or not the number of successive execution times reaches or exceeds a predetermined number of times (step S3). If step S3 is affirmative, an extra game is executed (step S4). It is determined whether or not to execute a second game by the extra game. Next, it is determined whether or not the extra game has brought a predetermined outcome (step S5). If step S5 is affirmative, a second game is executed (step S6). It is determined whether or not to execute a chance game by the second game. Next, it is determined whether or not the second game has brought a predetermined outcome (step S7). If step S7 is affirmative, a chance game is executed (step S8). It is determined whether or not that a jackpot prize is awarded.

### [Configuration of Poker Machine]

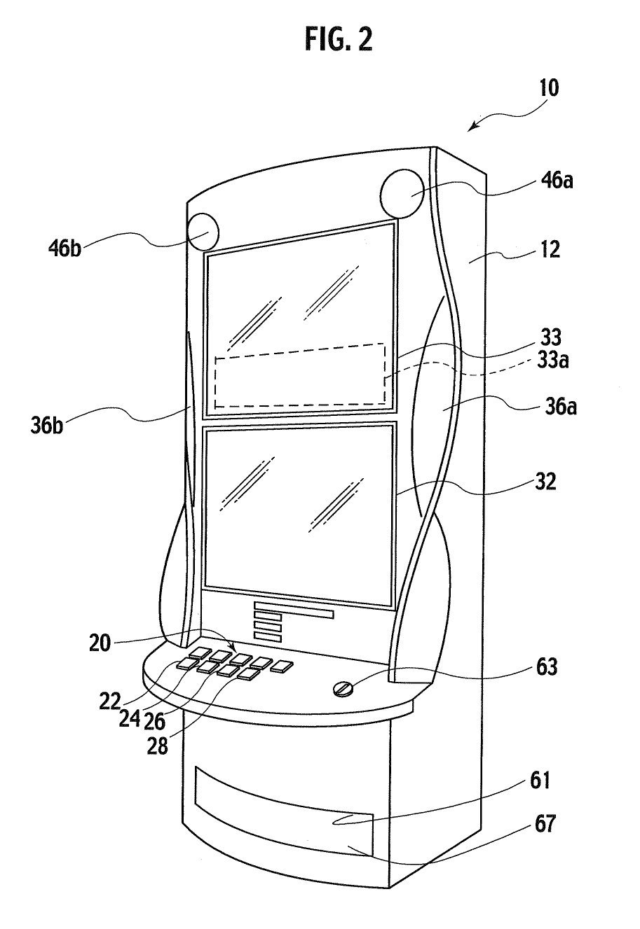

An appearance of a poker machine 10, which is an embodiment of the present invention, will be described. FIG. 2 is a perspective view of the poker machine 10. Note that, although medals are used as game media with the poker machine 10, coins, medals, tokens or cards storing information about gaming value may be used as game media.

A first display 32 for displaying images related to the base game, the extra game, and the chance game is provided on a front face of the poker machine 10. In addition, a second display 33 for displaying images related to the chance game and the second game is provided above the first display 32, independently from the first display 32. The first display 32 displays the cards dealt to the player and an odds table presenting card hands and payout amounts. A touch screen 33a is installed on at least a partial of the second display 33.

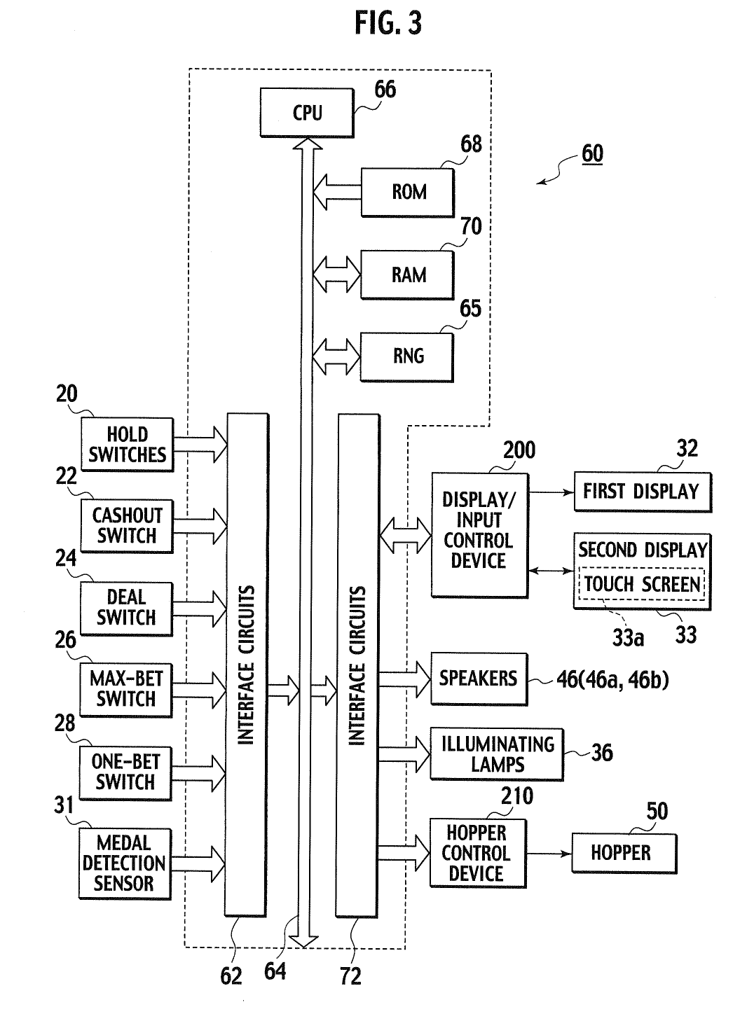

In addition, medal insertion slot 63 is provided on a right side of the front face. A medal cashout opening 61 and a medal receiver 67 are provided on a lower potion of the front face. A game can be played after a medal insertion into the medal insertion slot 63. In addition, medals are cashout from the medal cashout opening 61 according to the outcome of the gaming and accumulated on the medal receiver 67. As described below, a medal detection sensor 31 (see FIG. 3) is provided within the medal insertion slot 63. The medal detection sensor 31 detects insertion of medals into the poker machine 10 by the player.

In addition, speakers 46a and 46b are provided at an upper portion of the poker machine 10. The speakers 46a and 46b output sound effects along with progress of the game. Additionally, illuminating lamps 36a and 36b are provided at both right and left sides of the poker machine 10. The illuminating lamps 36a and 36b are illuminated along with the progress of the game.

Hold switches 20, a deal switch 24, a cashout switch 22, a max-bet switch 26, and a one-bet switch 28 used in the game are provided beneath the first display 32.

Five hold switches 20 are provided. The hold switches 20 are provided in association with respective card images displayed on the first display 32. Each of the hold switches 20 is used when the player selects a card to hold after cards are displayed. When the player presses one of the hold switches 20 beneath a card selected among five cards displayed on the first display 32, the selected card is held.

The cashout switch 22 and the deal switch 24 are provided at a left lower position to the hold switches 20. The cashout switch 22 is used when cashing-out credits accumulated within the poker machine 10. When the cashout switch 22 is pressed by the player, medals are cashed-out onto the medal receiver 67. The deal switch 24 is used when the player wants to receive dealing of the cards on the screen. When the deal switch 24 is pressed after the player inserted one or more medals, images of the dealt cards or newly replaced cards are displayed on the first display 32.

The max-bet switch 26 and the one-bet switch 28 are provided at a right side of the deal switch 24. The max-bet switch 26 and the one-bet switch 28 are used when the player starts the game. The max-bet switch 26 is used when a maximum number of medals (five) are bet at a time. The one-bet switch 28 increases a bet amount according to the number of times pressed.

### [Configuration of Control Unit of Poker Machine]

Next, a configuration of a control unit of the poker machine 10 will be described. FIG. 3 is a block diagram of a control circuit of the poker machine 10.

A main control circuit 60, which is a “controller”, includes a central processing unit (CPU) 66, a read-only memory (ROM) 68, a random access memory (RAM) 70, a random number generator (RNG) 65, and interface circuits 62 and 72. These components are connected each other via an input-output (I/O) bus 64. The I/O bus 64 inputs and outputs data signals, control signals, and address signals from/to the CPU 66.

The CPU 66 reads data from, and writes data into respective components connected to the I/O bus 64 based on computer programs stored in the ROM 68. The CPU 66 executes various processings in cooperation with such components. In addition, an after-mentioned timer (not shown) is pre-implemented within the CPU 66.

The ROM 68 and RAM 70, which are storage devices, are also connected to the I/O bus 64. Control programs for controlling the entire gaming of the poker machine 10 are stored in the ROM 68. In addition, initial data for executing the control programs, a control program for illuminating pattern of the illuminating lamps 36 (36a and 36b of FIG. 2), a display control program of the first display 32 or the like are stored in the ROM 68. Furthermore, various kinds of tables are stored in the ROM 68. The various kinds of tables include the following tables: base game sortition tables for associating the random numbers generated by the RNG 65 with card images to be displayed on the first display 32 in the base game; an extra game sortition table for associating card images to be displayed on the first display 32 with the random numbers generated by the RNG 65 in the extra game; a second game sortition table for associating card images to be displayed on the second display 33 with the random numbers generated by the RNG 65 in the second game; a chance game sortition table for associating card images to be displayed on the second display 33 with the random numbers generated by the RNG 65 in the chance game; and a combination determination table for determining whether or not a combination of card images displayed on the first display 32 has created a specific combination.

The above-mentioned base game sortition tables stored in the ROM 68 further include a general sortition table and a high-probability sortition table. The general sortition table has some of the random numbers to be determined as a winning in the general base game. The high-probability sortition table has more random numbers to be determined as a winning than the above-mentioned random numbers of the general sortition table.

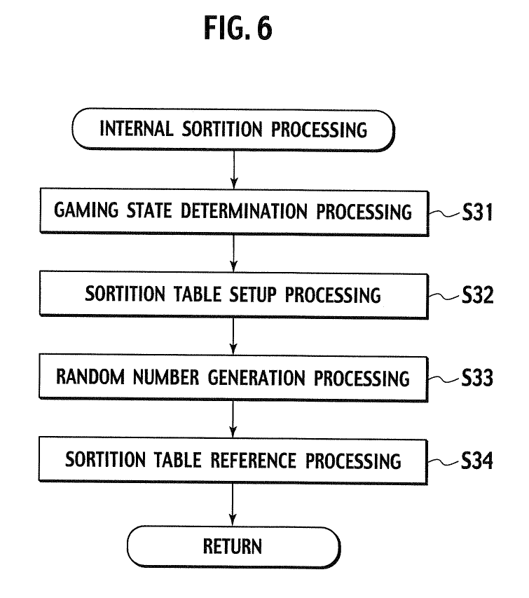

In other words, the general sortition table and the high-probability sortition table provide different winning probabilities, respectively. For example, the CPU 66 sets the high-probability sortition table as an internal sortition table when a specific combination is created by dealt cards (FIG. 6, Step S32). On the other hand, the general sortition table is set as the internal sortition table when the specific combination is not created by dealt cards.

The RAM 70 stores flags and parameters used in the above-mentioned programs. A high-probability flag, which indicates whether or not a gaming state is a high-probability gaming state, is stored in the RAM 70. In addition, the high-probability game counter, which indicates the number of times of the high-probability game had been executed successively, is also stored in the RAM 70. Furthermore, a value of a base game payout counter, which is an accumulated value of a difference calculated by subtracting a jackpot deduction amount from a base game payout amount, is also stored in the RAM 70. Furthermore, a value of a jackpot counter, which indicates an accumulation value of a jackpot, is also stored in the RAM 70.

In addition, the RNG 65 is connected to the I/O bus 64. The RNG 65 generates random numbers within a predetermined range when a random number generation command is transmitted from the CPU 66, and transmits a signal indicating the random numbers to the I/O bus 64. The CPU 66 executes an after-mentioned internal sortition processing based on the generated random numbers. Here, the random numbers transmitted from the RNG 65 are stored in the RAM 70.

In the present embodiment, random numbers are generated in the RNG 65 connected to the CPU 66 via the I/O bus 64. However, the present invention is not limited to the above configuration. Random number generation may be implemented in a program operating of the CPU 66 as a random number generator. In this case, the RNG 65 may be omitted.

The hold switches 20, the deal switch 24, the cashout switch 22, the max-bet switch 26, and the one-bet switch 28 are connected to the interface circuits 62. An operation detection signal is transmitted to the interface circuits 62 when each of these switches is pressed by the player. The interface circuits 62 supplies the operation detection signal to the I/O bus 64.

In addition, the above-mentioned medal detection sensor 31 is also connected to the interface circuits 62. The interface circuits 62 converts the detection signal transmitted from the medal detection sensor 31 into a predetermined signal and supplies the signal to the I/O bus 64.

A display/input control device 200 is connected to the interface circuits 72. The first display 32 and the second display 33 are connected to the display/input control device 200. The display/input control device 200 transmits driving signals to the first display 32 and the second display 33, based on image display commands transmitted from the main control circuit 60. In addition, the display/input control device 200 supplies an input signal, which is generated by an input to the touch screen 33a on the second display 33, to the interface circuits 72. The interface circuits 72 transmit the input signal to the CPU 66 via the I/O bus 64.

In addition, the speakers 46 (46a and 46b) and the illuminating lamps 36 (36a and 36b) are also connected to the interface circuits 72. The interface circuits 72 supply the driving signals and driving powers to the speakers 46 and the illuminating lamps 36 in order to control them, according to processing results of the CPU 66.

Furthermore, a hopper control device 210 is also connected to the interface circuits 72. A hopper 50 is connected to the hopper control device 210. The hopper control device 210 transmits a driving signal to the hopper 50 based on the medal cashout command transmitted from the main control circuit 60.

### [Operation of Poker Machine]

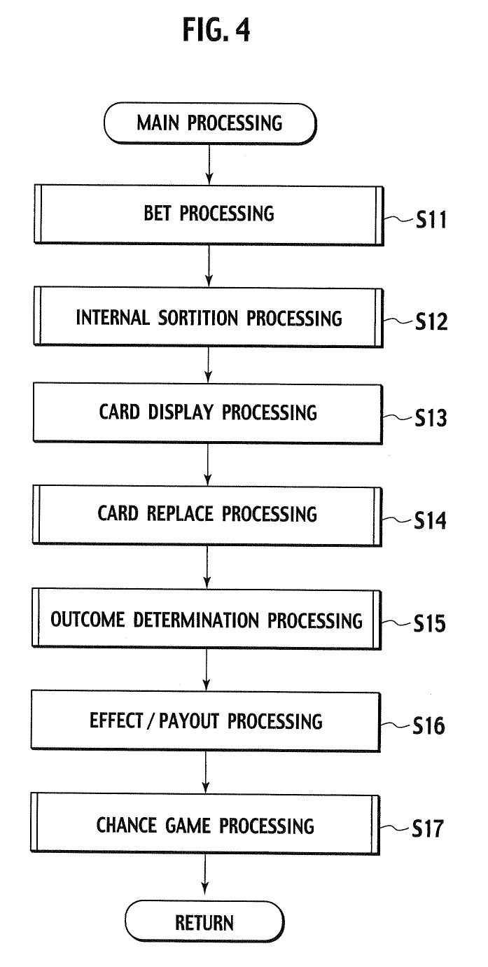

A main processing executed by the above-mentioned main control circuit 60 will be described. FIG. 4 is a flow chart of the main processing.

The poker machine 10 initializes the parameters used by the CPU 66 to default values upon activation to start the main processing. In the main processing, a bet processing is first executed (step S11). The bet processing is executed based on the player's inserting one or more coins or pressing the max-bet switch 26 or the one-bet switch 28. Details of the bet processing will be described below. The process flow proceeds to step S12 after the bet processing.

Next, an internal sortition processing is executed to determine cards to be dealt (step S12). In this processing, the CPU 66 transmits a command to generate random numbers to the RNG 65 and then the RNG 65 generates the random numbers. The random numbers generated by the RNG 65 are stored in the RAM 70 as an outcome of the internal sortition. The CPU 66 determines cards corresponding to the random numbers referring to the sortition table set in the RAM 70. And then, the CPU 66 stores data with regard to the cards in the RAM 70. Details of the internal sortition processing will be described below. The process flow proceeds to step S13 after the internal sortition processing.

Next, a card display processing is executed (step S13). The CPU 66 supplies the data, which relates to the five cards initially dealt to the player determined by the internal sortition processing of step S12 (stored in the RAM 70), together with a displaying order to the display/input control device 200 via the I/O bus 64 and the interface circuits 72. Here, the cards are dealt on the first display 32. The display/input control device 200 reads image data corresponding to the cards and stores the image data in an internal video RAM. In this manner, the five cards initially dealt to the player are displayed on the first display 32. The process flow proceeds to step S14 after the card display processing.

Next, a card replace processing is executed (step S14). In this processing, the CPU 66 displays new card image(s) on the first display 32 according to the player's card replacing operation. In this processing, the CPU 66 preliminarily determines whether or not a combination of the five cards to be displayed after card replacement creates a winning combination (one of poker hands), and changes the displaying order of the cards based on the result of the preliminary determination. Details of the processing will be described below. The process flow proceeds to step S15 after the card replace processing.

Next, an outcome determination processing is executed (step S15). In this processing, the CPU 66 determines whether or not a winning outcome, in which the finally dealt cards create a predetermined card combination (one of poker hands), has been brought. Furthermore, in this processing, the CPU 66 also determines whether or not the base games to be played subsequently will be executed as the high-probability games. Details of the processing will be described below. The process flow proceeds to step S16 after the outcome determination processing.

Next, an effect/payout processing is executed (step S16). In this processing, the CPU 66 provides a payout to the player and produces various effects (displaying images on the display 32 and 33, outputting sound effects from the speakers 46, illuminating of the lamps 36 and so on) based on the outcome determination processing of step S15. Specifically, if it is determined in step S15 that the card combination creates the winning combination (one of porker hands), the CPU 66 displays the fact on the first display 32. Furthermore, the CPU 66 provides a payout to the player. On the other hand, if it is determined in step S15 that the card combination does not create a winning combination, the CPU 66 displays the fact on the first display 32. The process flow proceeds to step S17 after the effect/payout processing.

Next, a chance game processing is executed (step S17). In this processing, the CPU 66 executes the extra game and the second game if predetermined conditions are met. Furthermore, if predetermined outcomes are brought in these games, the CPU 66 executes the chance game. Details of the processing will be described below. The main processing is terminated after the chance game processing.

In this way, the CPU 66 functions, in steps S11, S12, S15 and S16, as a part of the controller which controls the execution of the base game. In addition, the CPU 66 functions, in step S17, as a part of the controller which controls the execution of the extra game, the second game and the chance game.

### [Bet Processing]

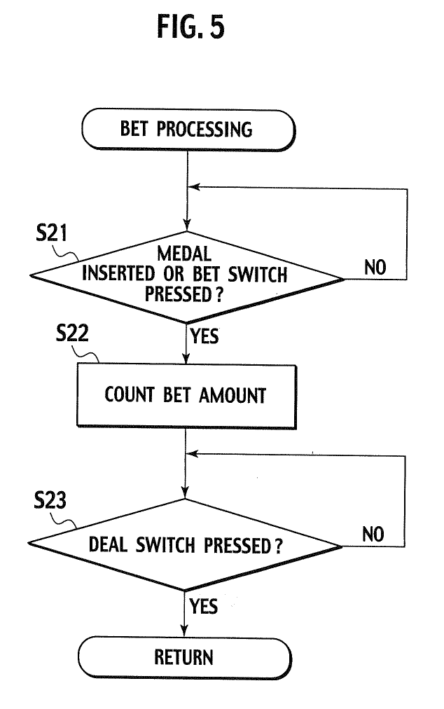

A subroutine (FIG. 5) of the bet processing is invoked in the above-mentioned step S11 (FIG. 4).

In the bet processing, it is first determined whether or not one or more medals have been inserted, or whether or not the bet switches 26 and 28 have been pressed (step S21). Here, the CPU 66 judges whether or not it has received a detection signal, which indicates that one or more medals have been inserted into the medal insertion slot 63, from the medal detection sensor 31 or a detection signal, which indicates that the max-bet switch 26 or the one-bet switch 28 has been pressed. The process flow proceeds to step S22 when the CPU 66 has received at least one of the detection signals. On the other hand, the CPU 66 repeats step S21 when it has not received any of the detection signals.

If step 21 is affirmative, a bet amount is counted (step S22). Here, the CPU 66 counts the bet amount based on the result of step S21. Specifically, a sum of the number of totally detected coins and the number of totally pressing times of the one-bet switch 28 is stored in the RAM 70 as the bet amount. Maximum value of a bet amount per one game is “5”. The maximal value of “5” is recorded in the RAM 70 regardless of the number of the detected coins or the pressing times of the one-bet switch 28 when the max-bet switch 26 is pressed. The process flow proceeds to step S23 after counting the bet amount.

Next, it is determined whether or not the deal switch 24 has been pressed (step S23). Here, the CPU 66 determines whether or not it has received a detection signal which indicates that deal switch 24 has been pressed. The CPU 66 repeats step S23 when it has not received the detection signal. On the other hand, the CPU 66 terminates the bet processing subroutine when it has received the detection signal.

### [Internal Sortition Processing]

A subroutine (FIG. 6) of the internal sortition processing is invoked in the above-mentioned step S12 (FIG. 4).

In the internal sortition processing, a gaming state determination processing is executed first (step S31). In this processing, the CPU 66 judges the gaming state based on the high-probability flag stored in the RAM 70. The process flow proceeds to step S32 after the gaming state is determined.

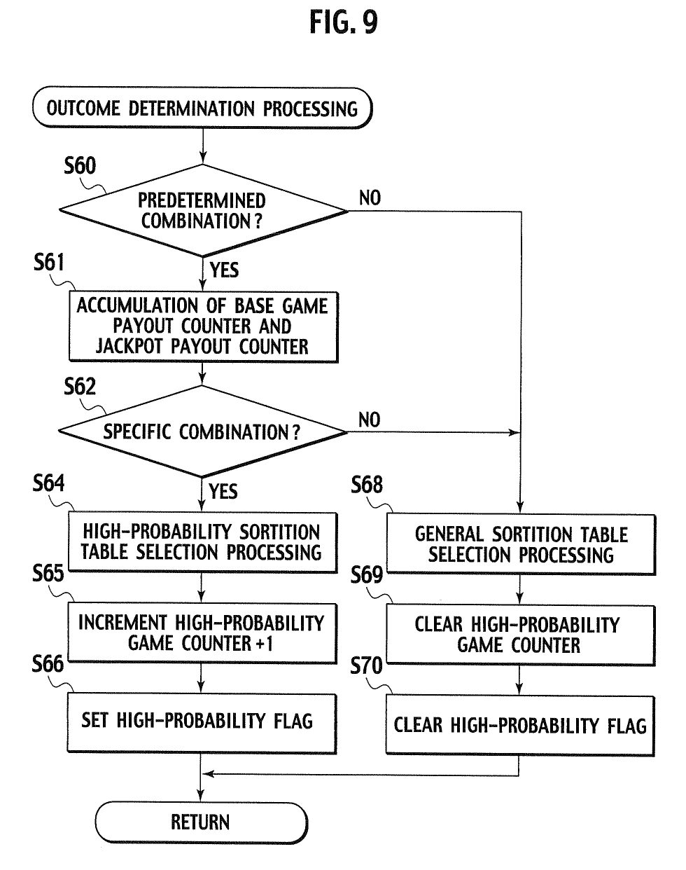

Next, a sortition table setup processing is executed (step S32). In this processing, the CPU 66 sets up a selected table in an after-mentioned outcome determination processing (FIG. 9) as the internal sortition table. The high-probability sortition table is selected at a high-probability sortition table selection processing (step S64 in FIG. 9), which will be described later in detail. The general sortition table is selected at a general sortition table selection processing (step S68 in FIG. 9), which will be also described later in detail. The process flow proceeds to step S33 after the sortition table setup processing. Note that, the general sortition table may be setup as the internal sortition table immediately after initialization of the poker machine 10.

Next, a random number generation processing is executed (step S33). In this processing, the CPU 66 transmits the random number generation command to the RNG 65. The RNG 65 generates the random numbers when it has received the command. The random numbers generated by the RNG 65 are stored in the RAM 70. The process flow proceeds to step S34 after the random number generation processing.

Next, a sortition table reference processing is executed (step S34). In this processing, the CPU 66 determines cards corresponding to the random numbers stored in the RAM 70 in step S33, referring to the sortition table setup in step S32. And then, the CPU 66 stores data related to the determined cards in the RAM 70. This subroutine is terminated after the sortition table reference processing.

In the internal sortition processing, ten cards are selected among cards used in the game. Five cards to be initially dealt to the player are included in the ten cards. Other five cards, which can be dealt to the player in card replacement, are also included in the ten cards. The five cards to be initially dealt are always displayed on the first display 32. Here, at least one joker is displayed as a wild card among the five cards to be initially dealt in the high-probability game. The joker raises probability that a winning combination (one of poker hands) is to be created. In addition, some of the other five cards can be displayed on the first display 32 as replacement(s) of card(s) which had been selected among the initially dealt cards by the player to be replaced. Note that, in the present embodiment, replace cards (the term “replace card” means a card to be replaced or a replaced card) are selected simultaneously with the initially dealt cards in the sortition as described above. However, the present invention is not limited to this, the replace card may be selected by the sortition after the player has selected card(s) among the initially dealt cards. In this case, the number of the replace cards selected by the sortition may be equal to the number of the card had been selected by the player.

### [Card Replacement Processing]

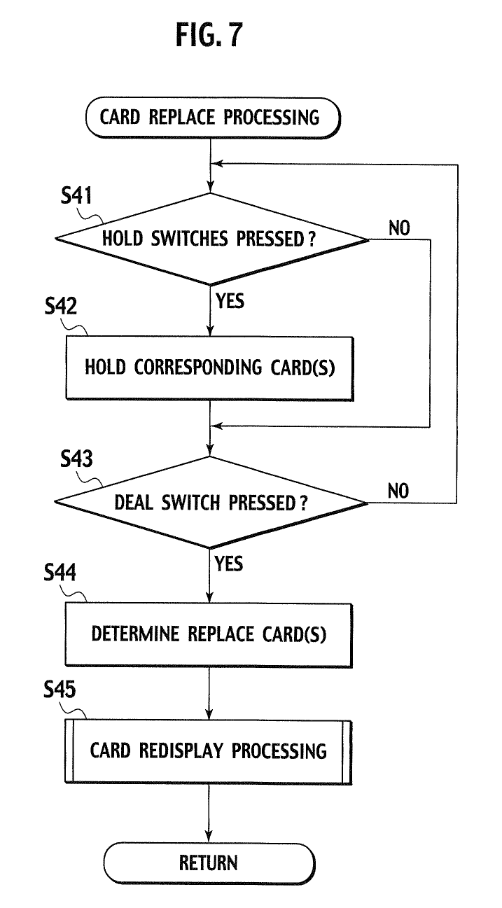

A subroutine (FIG. 7) of the card replacement processing is invoked in the above-mentioned step S14 (FIG. 4).

In the card replacement processing, it is first determined whether or not any of the hold switches 20 have been pressed (step S41). In this processing, the CPU 66 judges whether or not it has received a detection signal, which indicates that any of the five hold switches 20 has been pressed. The process flow proceeds to step S42 when the CPU 66 has received the detection signal. On the other hand, the process flow proceeds to step S43 when the CPU 66 has not received the detection signal.

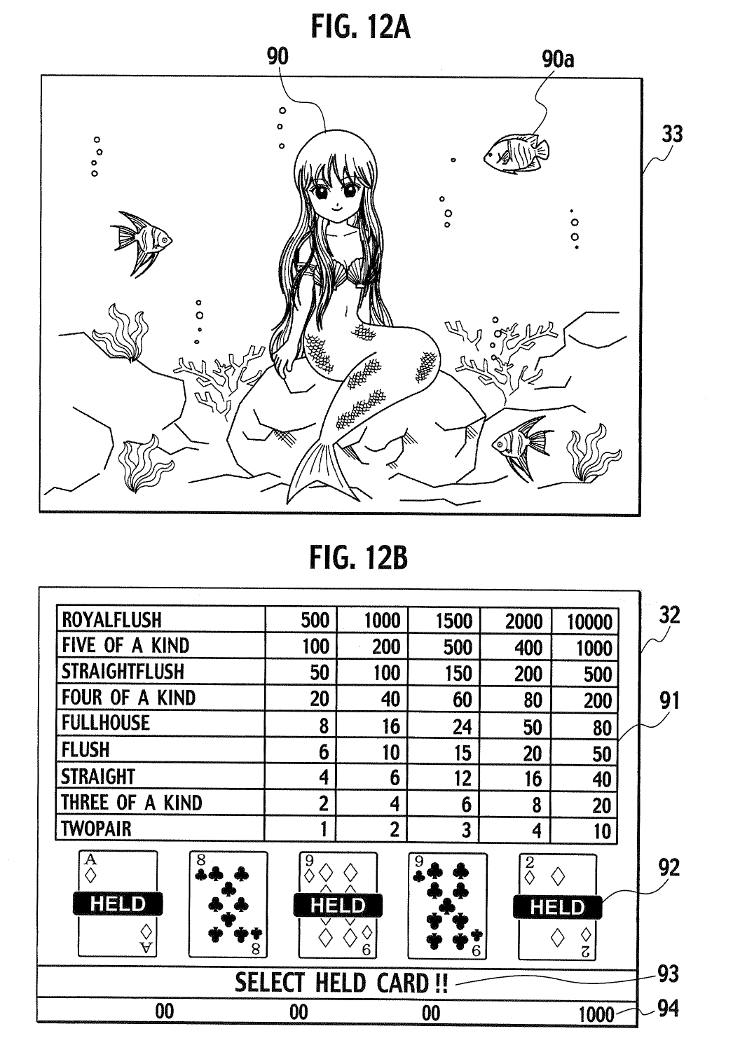

If step 41 is affirmative, the CPU 66 holds the corresponding card(s) to the pressed hold switch(es) 20 (step S42). Here, the CPU 66 executes a setup such that the hold card(s) (the term “hold card” represents a card corresponding to the hold switch 20 had been pressed in step S31) will not be replaced after the deal switch 24 is to be pressed. At the same time, the CPU 66 overlays the “HELD” image(s) on the hold card(s) on the first display 32 (FIG. 12B). The process flow proceeds to step S43 after the hold card(s) is determined.

If step 41 is negative or after step 42, the CPU 66 determines whether or not the deal switch 24 has been pressed (step S43). Here, the CPU 66 judges whether or not it has received a detection signal, which indicates that the deal switch 24 has been pressed. The process flow proceeds to step S44 when the CPU 66 has received the detection signal. On the other hand, the CPU 66 returns the process flow to step S41 when it has not received the detection signal.

Next, the CPU 66 determines the replace card(s) to be dealt (step S44). Here, the CPU 66 selects the card(s) to be replaced among the five replace cards selected by the sortition in step S12 (FIG. 4). The number of the card(s) selected by the CPU 66 for replacement is equal to the number of the non-hold cards (i.e., the number of cards the player wishes to replace). Selection of the replace cards may be executed in this step by new sortition among the five cards. Alternatively, the five replace cards may have been selected with an order at the sortition in step S12 (FIG. 4), and selected in this order in the new sortition of this step S44. Note that, there may be a case in which the player wishes to replace all five cards (all of the cards in hand). The process flow proceeds to step S45 after the replace card(s) is determined.

Next, the CPU 66 executes a card redisplay processing (step S45). In this processing, the CPU 66 transmits data related to the replace card(s) determined in step S34 to the display/input control device 200. The display/input control device 200 displays the replace card(s) as replacement(s) for the non-hold card(s) on the first display 32. Details of this processing will be described next. This subroutine is terminated after the card redisplay processing.

### [Card Redisplay Processing]

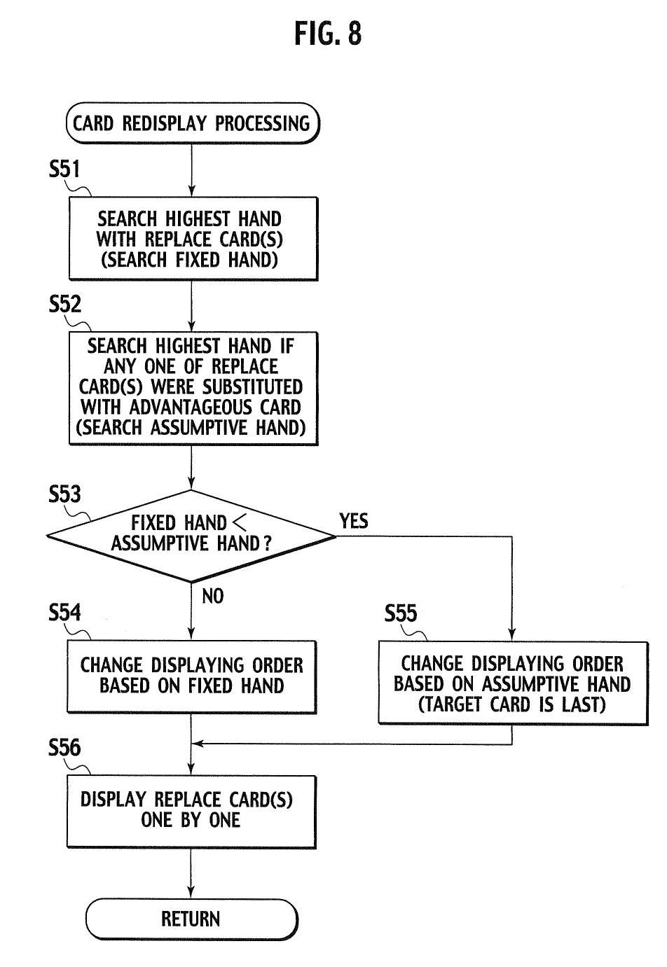

The card redisplay processing of step S45 (FIG. 7) will be described based on FIG. 8. More specifically, a case will be described in which (i) a “Spade 10”, a “Spade J”, a “Spade Q”, a “Diamond 3”, and a “Diamond 2” are initially dealt, (ii) a “Spade 10”, a “Spade J”, and a “Spade Q” are selected as hold cards by the player, and (iii) a “Diamond 10” and a “Spade K” are selected as replace cards by the sortition as replacements for the two non-hold cards.

In the card redisplay processing, the highest poker hand created by a combination of hold cards and replace cards is searched first (step S51). Since this hand is fixed after the card replacement, it is defined as a “fixed hand”. The CPU 66 searches for a fixed hand recorded in the ROM 68 based on the combination of the hold cards and the replace cards.

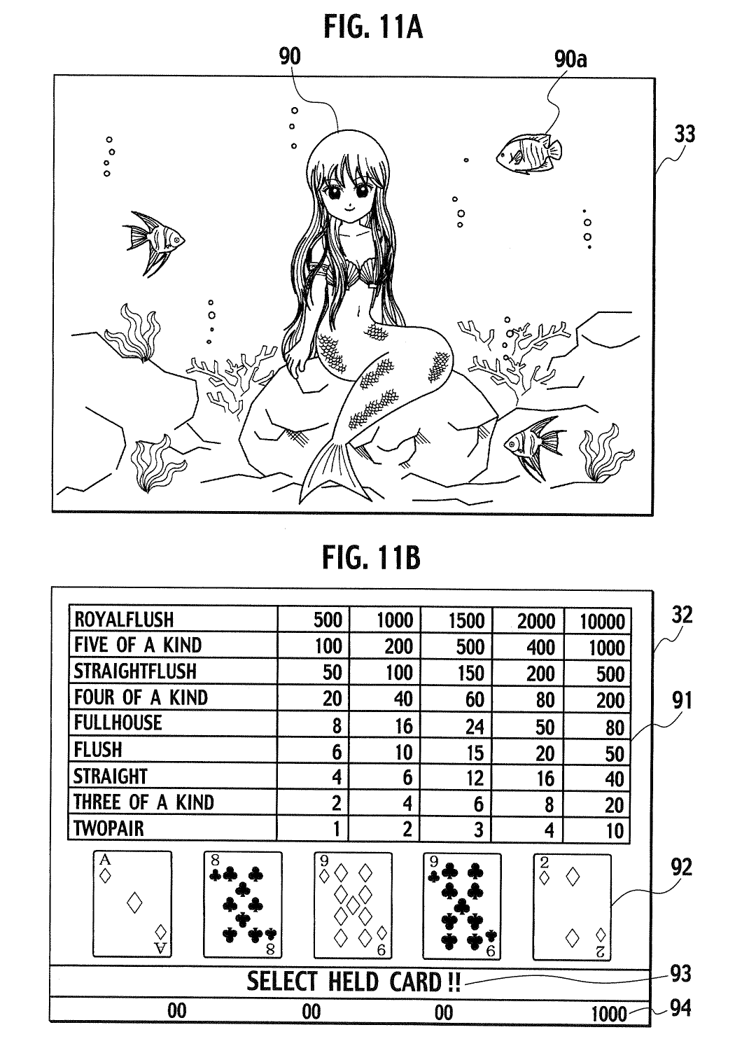

Poker hands, such as “royal flush” or “straight flush”, are stored in the ROM 68 together with their rank data. For example, as shown in the odds table (FIG. 11B) displayed on the first display 32, the rank of each poker hand is the payout amount per one credit (medal) according to the poker hand. For example, the ranks of “royal flush”, “straight flush”, and “four of a kind” are 500, 50, and 20, respectively. In this case, the larger the numeric value is, the higher the rank is. However, the ranks of poker hands may be ordinal numbers such as “1”, “2”, and “3” provided that they express the rank order of respective hands. The CPU 66 searches for the highest ranked poker hand according to the combination of the hold cards and the newly dealt replace cards. In the present embodiment, one pair of a “Spade J” and a “Diamond J” is searched as the fixed hand.

Next, the CPU 66 searches for the highest ranked hand if it is assumed that any one of the replace card(s) were substituted with a more advantageous card (step S52). Since this hand will not be created practically, it is defined as an “assumptive hand”. If it is assumed that one of the replace cards (e.g., a “Diamond J”) is substituted with another more advantageous card, the CPU 66 searches for the highest ranked hand. Specifically, the CPU 66 sequentially searches for winning hands by substituting the “Diamond J” with the other advantageous card in order to find the highest ranked hand. In the present embodiment, tentatively substituting the “Diamond J” with a “Spade A” creates “royal flush”. Alternatively, tentatively substituting the “Spade K” with a “Heart J” or a “Club J” creates “three of a kind” of Jack. Since “royal flush” is ranked higher than “three of a kind”, “royal flush” is retrieved as an assumptive hand in the case where the “Diamond J” is assumed as a “target card”.

Next, the CPU 66 compares the fixed hand of step S51 and the assumptive hand of step S52 (step S53). The process flow proceeds to step S54, if the rank of the assumptive hand is equal to or lower than that of the fixed hand. On the other hand, the process flow proceeds to step S55, if the rank of the assumptive hand is higher than that of the fixed hand.

If step 53 is negative, the CPU 66 changes the displaying order based on the fixed hand (step S54). For example, if the fixed-hand is one pair of a “Spade J” and a “Diamond J”, the displaying order is changed such that the replace card “Diamond J” will be displayed first.

On the other hand, if step 53 is affirmative, the CPU 66 changes the displaying order such that the target card in the assumptive hand will be displayed last (step S55). In the present embodiment, since the target card in the assumptive hand “royal flush” is a “Diamond J”, the displaying order is changed such that the “Diamond J” will be displayed last.

Next, the CPU 66 displays the replace cards in the displaying order determined in step S54 or S55 (step S56). Specifically, the CPU 66 first gives a command for displaying the first replace card to the display/input control device 200 via the I/O bus 64 and the interface circuits 72. The display/input control device 200 reads out the desired image data and stores it in the internal video RAM. In this manner, the first replace card is displayed on the first display 32. Subsequently, the CPU 66 gives a command for displaying the second replace card to the display/input control device 200 after a predetermined wait time, such as 0.2 to 2 seconds. And then, the CPU 66 displays the second replace card on the first display 32 via the display/input control device 200.

Therefore, the first card is replaced, so that the “Spade King” is displayed. Subsequently, the second card (target card) is replaced, so that the “Diamond J” is displayed. As a result, the fixed hand (one pair of Jack) is created. After step S56, this subroutine is terminated.

Here, the player may expect that a “royal flush” will be created if the next replace card is a “Spade A” when the first replace card “Spade K” has been displayed. In this manner, change of the displaying order of the replace cards based on the assumptive hand can provide the player with an expectation for a higher ranked hand until the last replace card is displayed.

### [Outcome Determination Processing]

A subroutine (FIG. 9) of the outcome determination processing is invoked in the above-mentioned step S15 (FIG. 4).

In the outcome determination processing, it is first determined whether or not the final card combination is a predetermined combination (step S60). In this processing, the CPU 66 judges whether or not the predetermined combination (e.g., one of winning porker hands) is created as an outcome of base game. If the predetermined combination is created, the process flow proceeds to step S61. On the other hand, if the predetermined combination is not created, the process flow proceeds to step S68.

If step S60 is affirmative, the base game payout counter and the jackpot payout counter are accumulated (step S61). Here, the CPU 66 determines the payout amount of the base game referring to the rank data stored in the ROM 68, based on the poker hand of the predetermined combination and the bet amount stored in the RAM 70. The CPU 66 adds some (e.g., 5%) of the base game payout amount to the jackpot payout counter. Furthermore, the CPU 66 adds a difference value, which is calculated by subtracting an above-mentioned jackpot deduction amount from the base game payout amount, to the base game payout counter.

Next, it is determined whether or not the final combination is a specific combination (step S62). Here, the CPU 66 judges whether or not the predetermined combination is a specific combination (e.g., “flush” of hearts or diamonds). The specific combination is one of plural kinds of the predetermined combinations. The process flow proceeds to step S64 when the predetermined is the specific combination. On the other hand, the process flow proceeds to step S68 when the predetermined is not the specific combination.

If step S62 is affirmative, the high-probability sortition table selection processing is executed (step S64). In this processing, the CPU 66 selects the high-probability sortition table stored in the ROM 68 as the internal sortition table.

Next, the high-probability game counter is incremented (step S65). Here, the CPU 66 adds one to the high-probability game counter stored in the RAM 70.

Next, the high-probability flag is set (step S66). Here, the CPU 66 sets the high-probability flag stored in the RAM 70 (flag is set on). After step S66, this subroutine is terminated.

If step S60 or S62 is negative, the general sortition table selection processing is executed (step S68). In this processing, the CPU 66 selects the general sortition table stored in the ROM 68 as the internal sortition table.

Next, the high-probability game counter is cleared (step S69). Here, the CPU 66 clears (resets) the high-probability game counter stored in the RAM 70 (counter is set to zero).

Next, the high-probability flag is cleared (step S70). Here, the CPU 66 clears (resets) the high-probability flag stored in the RAM 70 (flag is set off). After step S70, this subroutine is terminated.

### [Chance Game Processing]

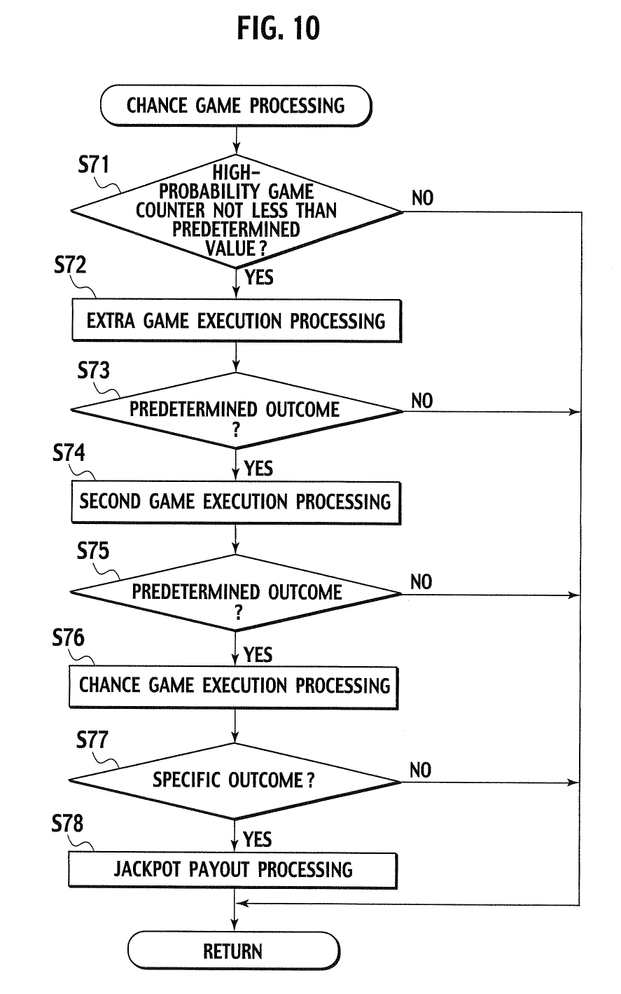

A subroutine (FIG. 10) of the chance game processing is invoked in the above-mentioned step S17 (FIG. 4).

In the chance game processing, it is first determined whether or not the high-probability game counter is not less than a predetermined value (step S71). Here, the CPU 66 judges whether or not the high-probability game counter stored in the RAM 70 is not less than the predetermined value (e.g., ten times. The process flow proceeds to step S72 when the counter is not less than the predetermined value. On the other hand, the CPU 66 terminates this subroutine when the counter is less than the predetermined value.

If step S71 is affirmative, an extra game execution processing is executed (step S72). In this processing, the CPU 66 executes the extra game for determining whether or not to execute the after-mentioned second game.

Next, it is determined whether or not the extra game has brought a predetermined outcome (step S73). Here, the CPU 66 judges whether or not the extra game executed in step S72 has brought the predetermined outcome. The process flow proceeds to step S74 when the extra game has brought the predetermined outcome. On the other hand, the CPU 66 terminates this subroutine when the extra game has not brought the predetermined outcome.

If step S73 is affirmative, the second game execution processing is executed (step S74). In this processing, the CPU 66 executes the second game for determining whether or not to execute the after-mentioned chance game.

Next, it is determined whether or not the second game has brought a predetermined outcome (step S75). Here, the CPU 66 judges whether or not the second game executed in step S74 has brought the predetermined outcome. The process flow proceeds to step S76 when the second game has brought the predetermined outcome. On the other hand, the CPU 66 terminates this subroutine when the second game has not brought the predetermined outcome.

If of step S75 is affirmative, the chance game execution processing is executed (step S76). In this processing, the CPU 66 executes the chance game for determining whether or not to award a jackpot prize.

Next, it is determined whether or not the chance game has brought a specific outcome (step S77). Here, the CPU 66 judges whether or not the chance game executed in step S76 has brought the specific outcome. The process flow proceeds to step S78 when the chance game has brought the specific outcome. On the other hand, the CPU 66 terminates this subroutine when the chance game has not brought the specific outcome.

If step S77 is affirmative, a jackpot payout processing is executed (step S78). In this processing, the CPU 66 provides a jackpot payout to the player according to the jackpot payout counter stored in the RAM 70. The CPU 66 clears (resets) the jackpot payout counter stored in the RAM 70 to a default value after providing the jackpot payout. After step S78, this subroutine is terminated.

### [Extra Game]

The extra game in the poker machine 10 of the present embodiment will be described specifically. In the extra game, the player can select one of the two face-down cards displayed on the first display 32. And then, it brings the above-mentioned predetermined outcome of the extra game that the selected card has a black suit (“club” or “spade”).

The CPU 66 first generates one random number by the RNG 65 in the extra game execution processing (step S72). The CPU 66 determines one pair of suit and number (including Ace, Jack, Queen and King) of a card to be displayed, and whether or not the extra game is going to bring the predetermined outcome, based the random number and the extra game sortition table stored in the ROM 68.

Next, the CPU 66 displays the two face-down cards on the first display 32 by the display/input control device 200. And then, the CPU 66 waits a detection signal transmitted from the hold switch 20 corresponding to one of the face-down cards after the player has selected the card. The CPU 66 turns the selected face-down card over and displays the suit and number of the card based on the determined card to be displayed.

### [Second Game]

The second game in the poker machine 10 of the present embodiment will be described specifically. In the second game, it brings the above-mentioned predetermined outcome of the second game that a sum of card numbers sequentially displayed on the second display 33 becomes just twenty-one (like “blackjack”).

The CPU 66 first generates four random numbers by the RNG 65 in the second game execution processing (step S74). The CPU 66 determines four pairs of suit and number of the cards to be sequentially displayed, and whether or not the second game is going to bring the predetermined outcome, based on the random numbers and the second game sortition table.

Next, the CPU 66 displays the cards determined above one by one on the second display 33 at each time it has received a detection signal transmitted from the hold switches 20. The player can request a next card by pressing any of the hold switches 20.

### [Chance Game]

The chance game in the poker machine 10 of the present embodiment will be described specifically. In the chance game, the player can select two cards (first and second selection cards) among four face-down cards displayed on an area of the touch screen 33a of the second display 33. And then, it brings the above-mentioned specific outcome of the chance game that the number of the second selection card is larger than that of the first selection card.

The CPU 66 first generates two random numbers by the RNG 65 in the chance game execution processing (step S76). The CPU 66 determines two pairs of suit and number of the two cards to be displayed as the first and second selection cards, and whether or not the chance game is going to bring the specific outcome, based on the random numbers and the chance game sortition table.

Next, the CPU 66 displays the four face-down cards on the area of the touch screen 33a of the second display 33 by the display/input control device 200. And then, the CPU 66 waits a detection signal transmitted from the touch screen 33a corresponding to one of the determined face-down cards after the player has touched the card to select the first selection card. The CPU 66 turns the touched face-down card (the first selection card) over and displays the suit and number of the card. Subsequently, the second selection card is also tuned over in the same way.

In the above example, the first and second selection cards are newly determined. However, the cards, which had been used in the second game, may be used in the chance game. In this case, the CPU 66 first turns the cards face-down and shuffles them. And then, the CPU 66 displays (moves) them on the touch screen 33a area by the display/input control device 200. The CPU 66 turns the touched face-down card (the first selection card) over and displays the suit and number of the card. The subsequent process flow is the same as the above example.

In this manner, the CPU 66 is an example of the controller, which is operable to (a) execute a base game, in which some cards selected by a player among initially dealt cards can be replaced with other cards and a payout is awarded if a predetermined combination is created by the finally dealt cards, (b) execute the base game to be played subsequently as a high-probability game with a raised winning probability for some game plays if the predetermined combination is a specific combination, (c) accumulate some of a payout amount for a jackpot, (d) execute a chance game for determining whether or not to award the jackpot based on the player's operation if the high-probability game has brought a predetermined outcome, (e) display images related to the base game on the first display, and (f) display images related to the chance game on the second display. In addition, the CPU 66 is an example of the controller, which is operable to execute a second game for determining whether or not to execute the chance game if the high-probability game has brought the predetermined outcome in (d), to display images related to the chance game on both the first display and the second display, and to display images related to the second game on the second display. Furthermore, the CPU 66 is an example of the controller, which is operable to execute an extra game for determining whether or not to execute the second game if the high-probability game has brought the predetermined outcome in (d), and to display images related to the base game and the extra game on the first display.

Note that, the outcome of the extra game has been preliminarily determined by internal sortition in the present embodiment. However, the present invention is not limited to this. For example, two pairs of suit and number of two face-down cards may be preliminary determined and stored in the RAM 70. And then, an outcome of the extra game may be brought by an actually selected card by the player between the two cards. The extra game may bring the predetermined outcome when actually opened cards by the player has black suit.

Additionally, the outcome of the second game has been preliminarily determined by internal sortition in the present embodiment. However, the present invention is not limited to this. For example, four pairs of suit and number of four face-down cards to be sequentially displayed may be preliminary determined and stored in the RAM 70. And then, an outcome of the second game may be brought by actually selected cards by the player. The second game may bring the predetermined outcome when a sum of the numbers of actually opened cards by the player becomes just twenty one.

Furthermore, the outcome of the chance game has been preliminarily determined by the internal sortition in the present embodiment. However, the present invention is not limited to this. For example, all the cards to be displayed with their faces down are preliminary determined by internal sortition. The numbers of the first and second selection cards actually selected by the player are stored in the RAM 70. The chance game may bring the specific outcome when the number of the second selection card is larger than that of the first selection card.

### [Display of Poker Machine]

FIGS. 11A and 11B are explanatory views illustrating an example of display screens. FIG. 11A illustrates a display screen of the second display 33 and FIG. 11B illustrates a display screen of the first display 32. The second display 33 displays a character image 90 (e.g., image of a sitting mermaid) and a character image 90a (e.g., image of a fish swimming in the water). In addition, the first display 32 displays an image 91 (e.g., poker odds table) and images 92 (e.g., card images). Furthermore, the first display 32 displays a text string image 93 (e.g., “SELECT HELD CARD!!”), a text string image 94 indicating credits (e.g., “00, 00, 00, 1000”) and so on.

FIGS. 12A and 12B illustrate the display screens after the hold switches 20 have been pressed on the displays shown in FIGS. 11A and 11B. FIG. 12A illustrates the display screen of the second display 33 and FIG. 12B illustrates the display screen of the first display 32. The second display 33 displays the character image 90 (e.g., image of the sitting mermaid) and the character image 90a (e.g., image of the fish swimming in the water). In addition, the first display 32 displays the image 91 (e.g., poker odds table) and the images 92 (e.g., card images including cards with text string images “HELD” overlaid thereon). Furthermore, the first display 32 displays the text string image 93 (e.g., “SELECT HELD CARD!!”), the text string image 94 indicating credits (e.g., “1000”) and so on.

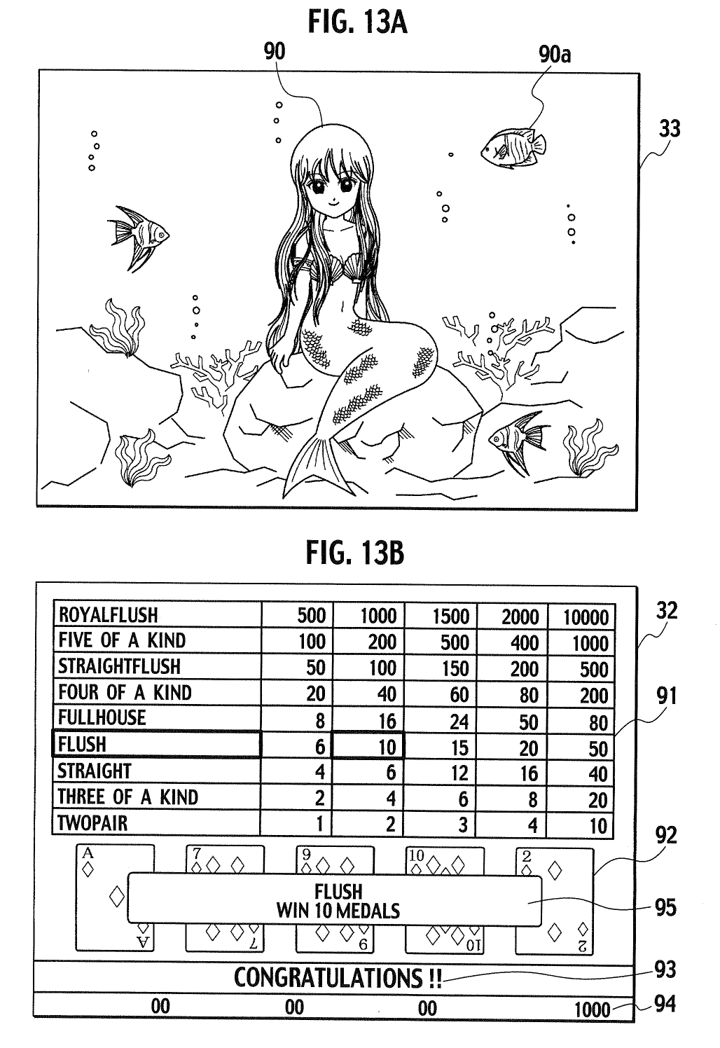

FIGS. 13A and 13B illustrate the display screens after the deal switch is pressed on the displays shown in FIGS. 12A and 12B. FIG. 13A illustrates the display screen of the second display 33 and FIG. 13B illustrates the display screen of the first display 32. The second display 33 displays the character image 90 (e.g., image of the sitting mermaid) and the character image 90a (e.g., image of the fish swimming in the water). In addition, the first display 32 displays the image 91 (e.g., poker odds table with grids “FLUSH” and “10” highlighted) and the images 92 (e.g., card images). Furthermore, the first display 32 displays a text string image 93 (e.g., “CONGRATULATIONS!!”), the text string image 94 representing credits (e.g., “1000”), a text string image 95 (e.g., “FLUSH WIN 10 MEDALS”) and so on.

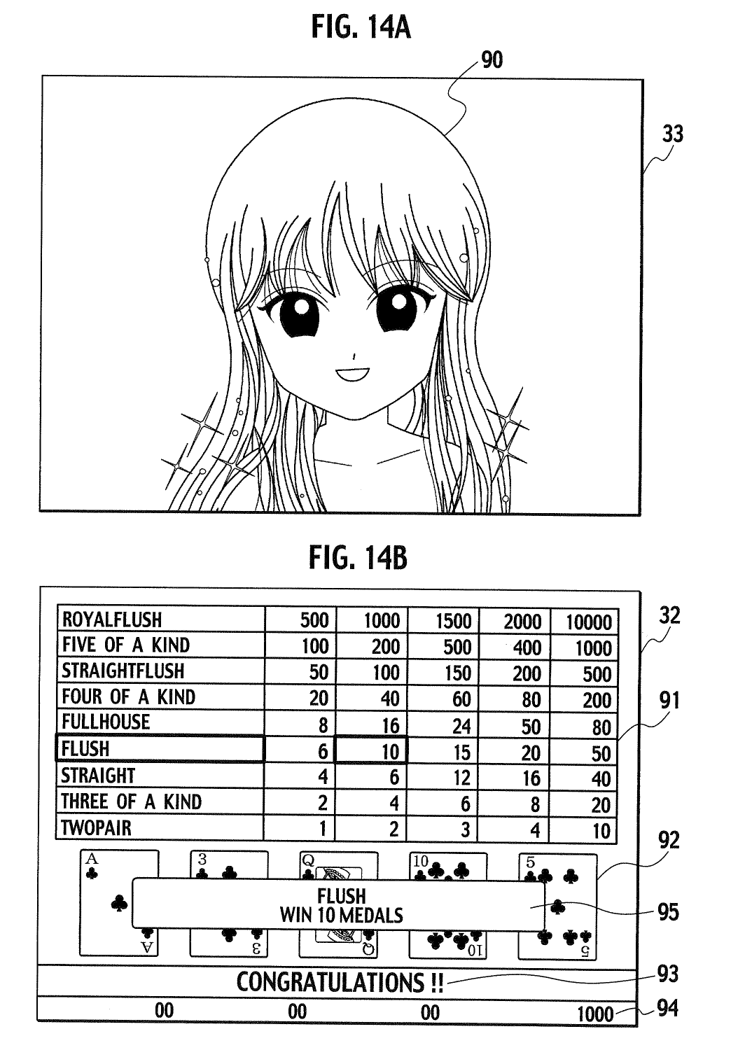

FIGS. 14A and 14B illustrate the display screens immediately after the high-probability game has started. FIG. 14A illustrates the display screen of the second display 33 and FIG. 14B illustrates the display screen of the first display 32. The second display 33 displays the character image 90 (e.g. close up image of the mermaid). In addition, the first display 32 displays the image 91 (e.g., poker odds table with grids “FLUSH” and “10” highlighted), the images 92 (e.g., card images) and so on. Furthermore, the first display 32 displays the text string image 93 (e.g., “CONGRATULATIONS!!”), the text string image 94 indicating credits (e.g., “1000”), the text string image 95 (e.g., “FLUSH WIN 10 MEDALS”) and so on.

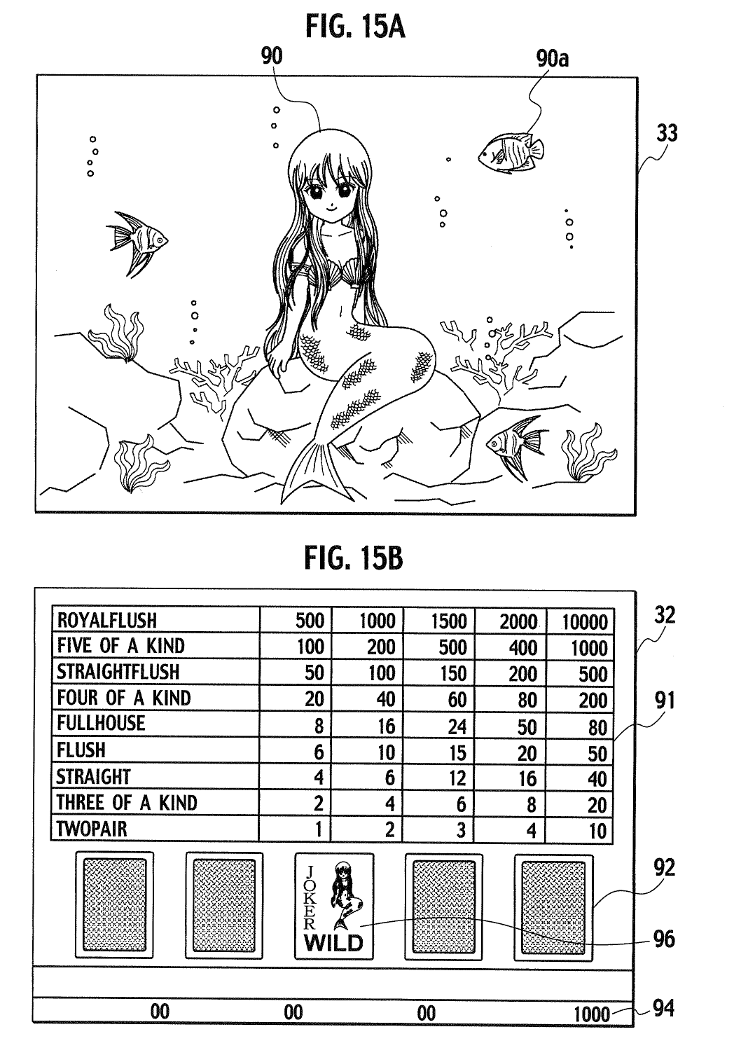

FIGS. 15A and 15B illustrate the display screens in the high-probability game. FIG. 15A illustrates the display screen of the second display 33 and FIG. 15B illustrates the display screen of the first display 32. The second display 33 displays the character image 90 (e.g., image of the sitting mermaid) and the character image 90a (e.g., image of the fish swimming in the water). In addition, the first display 32 displays the image 91 (e.g., poker odds table), the images 92 (e.g., face-down card images) and an image 96 (e.g., extra card [joker] image with the mermaid illustrated thereon). Furthermore, the first display 32 displays the text string image 94 indicating credits (e.g., “1000”) and so on.

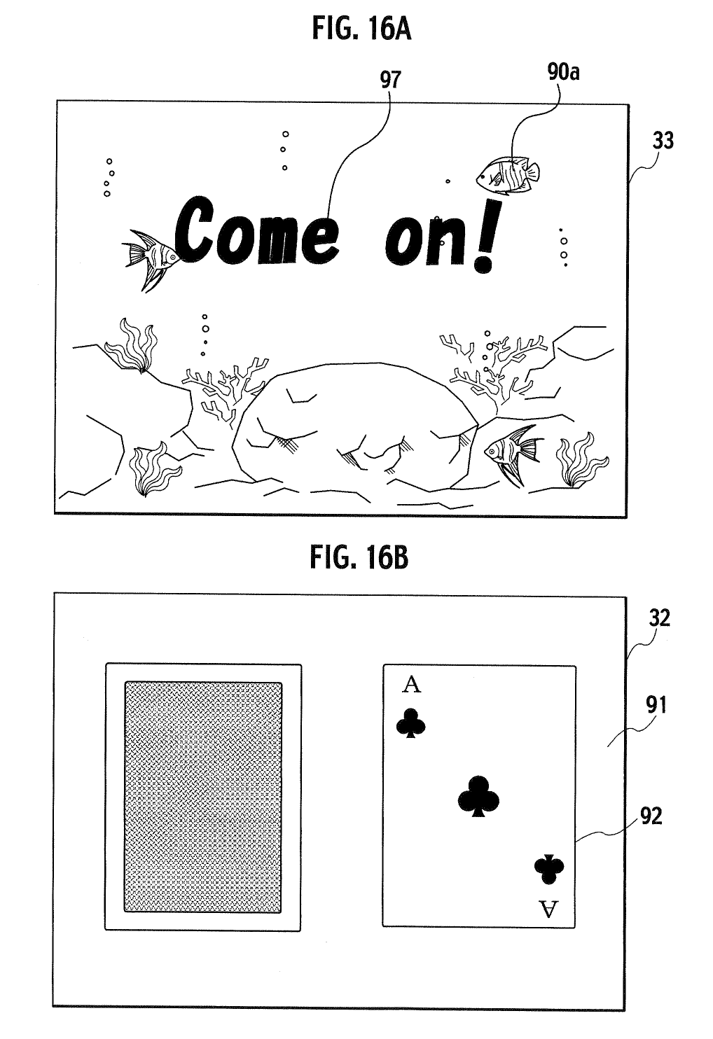

FIGS. 16A and 16B illustrate the display screens when the extra game has brought the predetermined outcome. FIG. 16A illustrates the display screen of the second display 33 and FIG. 16B illustrates the display screen of the first display 32. The second display 33 displays a text string image 97 (e.g., “come on!”) and the character image 90a (e.g., image of the fish swimming in the water). In addition, the first display 32 displays images 92 (e.g., a face-down card image and a card image of “Club A”).

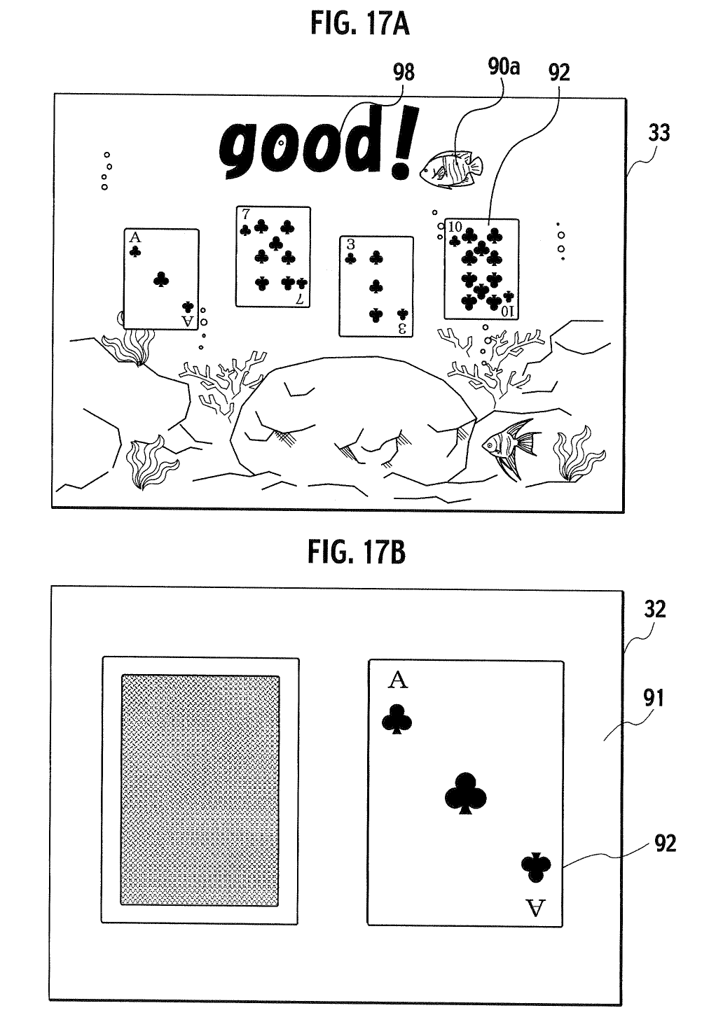

FIGS. 17A and 17B illustrate the display screens when the second game has brought the predetermined outcome. FIG. 17A illustrates the display screen of the second display 33 and FIG. 17B illustrates the display screen of the first display 32. The second display 33 displays a text string image 98 (e.g., “good!”) and the character image 90a (e.g., image of the fish swimming in the water). In addition, the first display 32 still displays a final state of the extra game. In other words, the first display 32 displays the images 92 (e.g., the face-down card image and the card image of “Club A”).

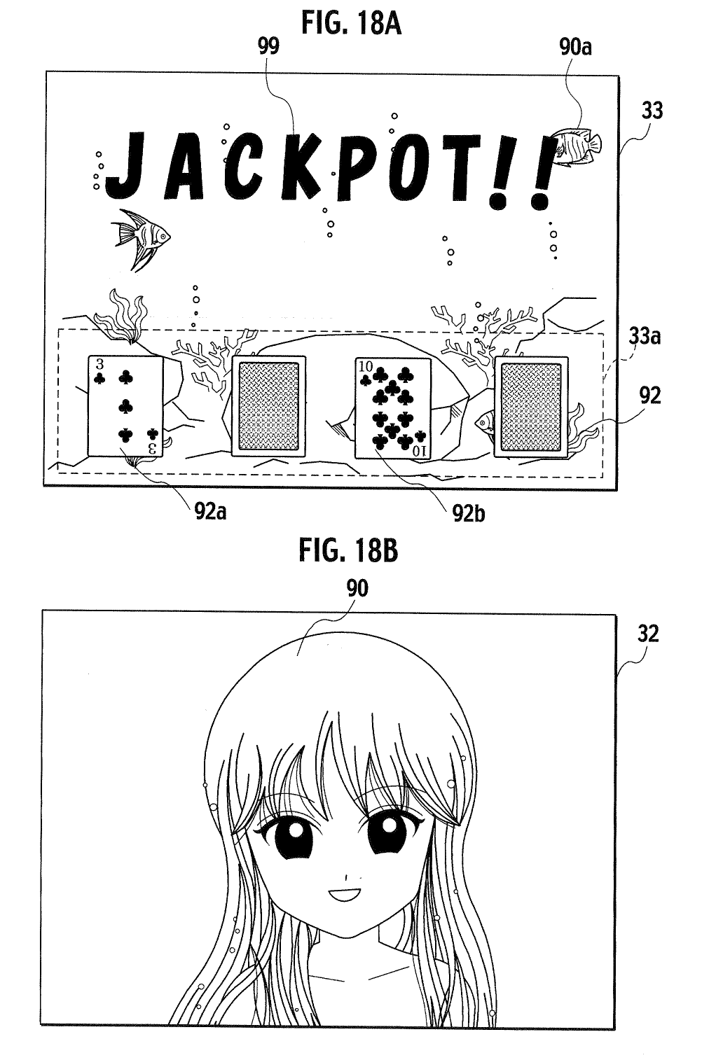

FIGS. 18A and 18B illustrate the display screens when the chance game has brought the specific outcome. FIG. 18A illustrates the display screen of the second display 33 and FIG. 18B illustrates the display screen of the first display 32. The second display 33 displays a text string image 99 (e.g., “JACKPOT!!”) and the character image 90a (e.g., image of the fish swimming in the water). Furthermore, the second display 33 displays the images 92 (e.g., face-down card images), an image 92a of the first selection card (e.g., card image of “Club 3”) and an image 92b of the second selection card (e.g., card image of “Club 10”) within the area of the touch screen 33a. In addition, the first display 32 displays the character image 90 (e.g., close up image of the mermaid).

An example of the present invention has been described based on the above embodiment. However, the present invention is not limited to the above. The applicant intends that the scope which a person having ordinary skill can readily conceive, and that equivalents or substitutes of the components belong to the scope of the present invention.

What is claimed is:

1. A gaming machine for playing with plural kinds of cards, comprising:
a controller operable to:
(a) execute a base game, in which some cards selected by a player among initially dealt cards can be replaced with other cards and a payout is awarded if a predetermined combination is created by the finally dealt cards,
(b) execute the base game to be played subsequently as a high-probability game with a raised winning probability for some game plays if the predetermined combination is a specific combination,
(c) accumulate some of a payout amount for a jackpot, and
(d) execute a chance game for determining whether or not to award the jackpot based on the player's operation if the high-probability game has brought a predetermined outcome;
a first display controlled by the controller for displaying images related to the base game; and
a second display controlled by the controller and provided independently from the first display for displaying images related to the chance game.

2. The gaming machine according to claim 1, wherein
the controller is operable to:
execute a second game for determining whether or not to execute the chance game if the high-probability game has brought the predetermined outcome in (d),
display images related to the chance game on both the first display and the second display, and
display images related to the second game on the second display.

3. The gaming machine according to claim 2, wherein
the controller is operable to:
execute an extra game for determining whether or not to execute the second game if the high-probability game has brought the predetermined outcome in (d), and
display images related to the base game and the extra game on the first display.

4. A gaming machine for playing with plural kinds of cards, comprising:
a controller operable to:
(a) execute abase game, in which some cards selected by a player among initially dealt cards can be replaced with other cards and a payout is awarded to a player if a predetermined combination is created by the finally dealt cards,
(b) execute the base game to be played subsequently as a high-probability game with a raised winning probability for some game plays if the predetermined combination is a specific combination,
(c) accumulate some of a payout amount for a jackpot, and
(d) execute a second game if the high-probability game has brought a predetermined outcome, and
(e) execute a chance game for determining whether or not to award the jackpot based on the player's operation if the second game has brought a predetermined outcome;
a first display controlled by the controller for displaying images related to the base game and the chance game; and
a second display controlled by the controller and provided independently from the first display for displaying images related to the second game and the chance game.

5. The gaming machine according to claim 4, wherein
the controller is operable to:
execute an extra game for determining whether or not to execute the second game if the high-probability game has brought the predetermined outcome in (d), and
display images related to the base game and the extra game on the first display.

6. A gaming machine for playing with plural kinds of cards, comprising:
a controller operable to:
(a) execute a base game, in which some cards selected by a player among initially dealt cards can be replaced with other cards and a payout is awarded if a predetermined combination is created by the finally dealt cards,
(b) execute the base game to be played subsequently as a high-probability game with a raised winning probability for some game plays if the predetermined combination is a specific combination,
(c) accumulate some of a payout amount for a jackpot,
(d) execute an extra game if the high-probability game has brought a predetermined outcome,
(e) execute a second game if the extra game has brought a predetermined outcome, and
(f) execute a chance game for determining whether or not to award the jackpot based on the player's operation if the second game has brought a predetermined outcome;
a first display controlled by the controller for displaying images related to the base game, the extra game, and the chance game; and
a second display controlled by the controller and provided independently from the first display for displaying images related to the second game and the chance game.

7. A control method of a gaming machine, which executes a game with plural kinds of cards and comprises a controller, a first display and a second display provided independently from the first display, wherein
the controller is operable to:
(a) execute a base game, in which some cards selected by a player among initially dealt cards can be replaced with other cards and a payout is awarded if a predetermined combination is created by the finally dealt cards,
(b) execute the base game to be played subsequently as a high-probability game with a raised winning probability for some game plays if the predetermined combination is a specific combination,
(c) accumulate some of a payout amount for a jackpot,
(d) execute a chance game for determining whether or not to award the jackpot based on the player's operation if the high-probability game has brought a predetermined outcome,
(e) display images related to the base game on the first display, and
(f) display images related to the chance game on the second display.

8. The control method of a gaming machine according to claim 7, wherein
the controller is operable to:
execute a second game for determining whether or not to execute the chance game if the high-probability game has brought the predetermined outcome in (d),
display images related to the chance game on both the first display and the second display, and
display images related to the second game on the second display.

9. The control method of a gaming machine according to claim 8, wherein
the controller is operable to:
execute an extra game for determining whether or not to execute the second game if the high-probability game has brought the predetermined outcome in (d), and
display images related to the base game and the extra game on the first display.

10. A playing method of a card game, comprising:
(a) executing a base game at first gaming field, in which some cards selected by a player among initially dealt cards can be replaced with other cards and a payout is awarded if a predetermined combination is created by the finally dealt cards;
(b) executing the base game to be played subsequently as a high-probability game with a raised winning probability for some game plays if the predetermined combination is a specific combination;
(c) accumulating some of a payout amount for a jackpot; and
(d) executing a chance game at a second gaming field for determining whether or not to award the jackpot based on the player's operation if the high-probability game has brought a predetermined outcome, the second gaming field being provided independently from the first gaming field.
